(19) United States
(12) Patent Application Publication
(10) Pub. No.: US 2010/0118305 A1
(43) Pub. Date: May 13, 2010

(54) Process and device for measuring the rotation angle of a rotating object

(75) Inventors: Josef Siraky, Donaueschingen (DE); Mark Johnson, Lymm (GB)

Correspondence Address: THE NATH LAW GROUP, 112 South West Street, Alexandria, VA, 22314, US

(73) Assignee: SICK STEGMANN GmbH, Donaueschingen (DE)

(21) Appl. No.: 12/591,268

(22) Filed: Nov. 13, 2009

(30) Foreign Application Priority Data
Nov. 13, 2008 (EP) 08 019 864.1

(51) Int. Cl. G01J 4/00; G01B 11/26

(52) U.S. Cl. 356/368; 356/138

(57) ABSTRACT

To measure the rotation angle of two objects rotating in relation to each other, a transmitter (12) emits at least two linearly polarized light rays (a, b, d, c, d), whose polarization planes are rotated relative to one another. The light passes through a polarization filter (16), which revolves relative to the transmitter in dependence on the angle of rotation. The intensity of the light rays (a, b, d, c) is modulated in phase-shifted fashion. The intensity of the light that passes through the polarization filter (16) is measured by a receiver (18) and is evaluated as a signal that is dependent on the rotation angle.

The invention relates to a process for measuring the rotation angle of a rotating object according to the preamble of patent claim 1 and to a device for measuring the rotation angle of a rotating object according to the preamble of patent claim 6.

In many technical applications it is necessary to measure the rotation angle of a rotating object. Generally the rotation angle of the rotating object is measured in relation to a stationary object, e.g., the rotation angle of a rotating wheel in relation to a stationary motor part or machine part. However, the invention also includes cases in which a rotating object revolves in relation to another rotating object and the relative rotation angle between the two objects is to be measured. According to the invention, the measurement of the rotation angle also includes the measurement of magnitudes derived from the rotation angle, e.g., the angular velocity and the angular acceleration. Measurement of the rotation angle, as specified by the invention, also includes cases in which a linear motion is converted into a rotational motion, e.g., by a gear, and the position, velocity, acceleration, etc. of the linear motion is to be measured using the rotation angle of the rotating object.

To measure the rotation angle, it is known to scan a material measure assigned to the rotating object, where this material measure is coded in absolute fashion or is incrementally scanned. In particular, it is known to utilize the polarization of light to measure the rotation angle. Here light that has been linearly polarized using a polarizer is emitted by a transmitter and reaches a receiver after passing through an analyzer that revolves in correspondence with the rotating object. If the analyzer and its polarization plane lie parallel to the polarizer, the light will enter the receiver, while no light will enter the receiver if the polarization plane of the analyzer lies perpendicular to the polarization plane of the emitted light. The receiver thus delivers a signal that is dependent on the rotation angle of the analyzer and thus is dependent on the rotation angle of the rotating object.

In an arrangement known from DE 10 2005 031 966 A1, unpolarized light is emitted by a transmitter and strikes a polarizing filter which revolves with the rotating object. The light passing through the polarizing filter is polarized, and its polarization plane revolves with the polarizing filter. The light strikes a receiver, on whose light-intake side four polarizing filters are positioned in an array; their polarization planes are each rotated 45° relative to each other. With each 45° turn of the rotating polarizing filter, its polarization plane coincides with the polarization plane of a polarizing filter belonging to the receiver, so that there is a maximum in received optical intensity and thus a maximal receiver signal.

In an arrangement known from DE 201 02 192 U1, a transmitter emits linearly polarized light, which strikes a polarizing filter that has a reflector positioned behind it and that rotates with the rotating object. Two receivers with polarizing filters rotated 90° relative to each other receive the reflected light, and the signals from the two receivers create a signal that is dependent on object's angle of rotation.

The invention is based on the problem of providing a process and a device for measuring the rotation angle of a rotating object, in order to permit an improvement in signal evaluation by using optical polarization as a tool.

The invention solves this problem with a process having the features of patent claim 1 and a device having the features of patent claim 6.

Advantageous embodiments of the invention are indicated in the secondary claims.

In accordance with the invention, the transmitter gives out at least two linearly polarized light rays, whose polarization planes are rotated relative to one another. If the analyzer and the transmitter revolve relative to each other in correspondence with the rotation of the object that is being measured, the polarization planes of the polarized light rays from the transmitter will successively coincide with the polarization planes of the analyzer, so that the light striking the receiver has an intensity that is dependent on the angle of rotation. In addition, however, the intensities of the light rays emitted by the transmitter are modulated, and specifically modulated in a phase-shifted fashion relative to each other. The intensity of the light striking the receiver, and therefore the signal strength, are thus influenced not only by the rotation angle, but also by the modulation of the light rays in their intensity. The receiver signal, which corresponds to the optical intensity of the light striking the receiver, thus depends on the modulation frequency of the lights rays emitted by the transmitter and on the rotation angle being measured. In particular, a receiver signal is produced which contains the modulation frequency of the light rays emitted by the transmitter and which is phase-shifted in accordance with the rotation angle being measured.

In evaluating the signals of the receiver it is advantageous if simple trigonometric functions are selected to modulate the intensity of the emitted light rays. It is also advantageous for the polarization planes of the radiated light rays to have simple trigonometric relationships among themselves.

For this reason, it is useful for the intensity of the light rays emitted by the transmitter to be modulated in sinusoidal fashion. A phase shift of 360°/n, where n is the number of light rays, can be advantageously chosen for the modulation of the individual light rays.

Furthermore, it is advantageous if the polarization planes of the light rays emitted by the transmitter are each rotated 180°/n relative to each other, where n is again the number of emitted light rays.

In a simplest embodiment, two linearly polarized light rays are emitted by the transmitter. When there is a larger number of light rays, the evaluation will benefit if the number n of light rays is a whole-number multiple of two.

With a view to expense and the advantageous evaluation of the signals, an embodiment is preferred in which four linearly polarized light rays, whose intensity is in each case modulated in sinusoidal fashion, are emitted by the transmitter, such that the phase shift in the modulation of the individual light rays in each case is 90°. The polarization planes of these light rays are each rotated 45° relative to each other.

In principle, the solution according to the invention can be so realized that the transmitter revolves in dependence on the rotating object while the analyzer remains stationary; or the transmitter may remain stationary while the analyzer revolves in dependence on the rotating object.

If the transmitter revolves in dependence on the rotating object, a suitable energy supply must be provided for the rotating transmitter. When the analyzer is positioned in stationary position, the receiver can be simply positioned in stationary fashion behind the polarizing filter of the analyzer. In the simplest embodiment, the polarizing filter can be positioned directly on the surface of the receiver.

If the transmitter is positioned in stationary fashion, its energy supply becomes easier to provide. The analyzer will then revolve in correspondence with the revolution of the rotating object. When the receiver revolves with the analyzer, difficulties arise in transmitting the analog receiver signals. Consequently, an embodiment is preferred in which only the analyzer revolves and the light passing through the analyzer is deflected to a receiver positioned in stationary fashion.

The invention is next described in greater detail on the basis of exemplary embodiments depicted in the drawing. Shown are:

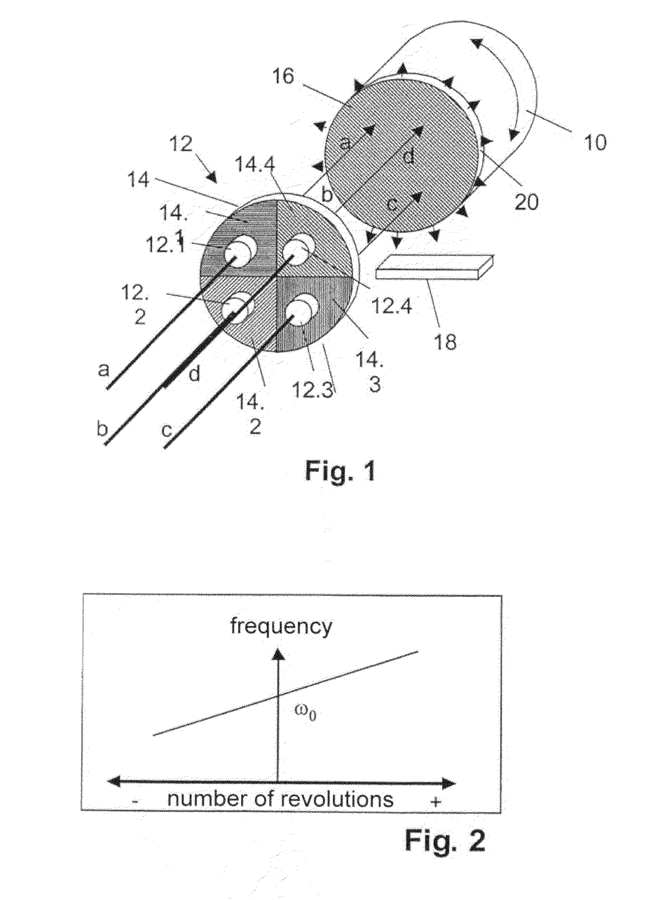

FIG. 1 an initial embodiment of the invention, schematically depicted in a perspective view

FIG. 2 a diagram showing the optical intensity received by the receiver as dependent on the modulation frequency and the rotation angle

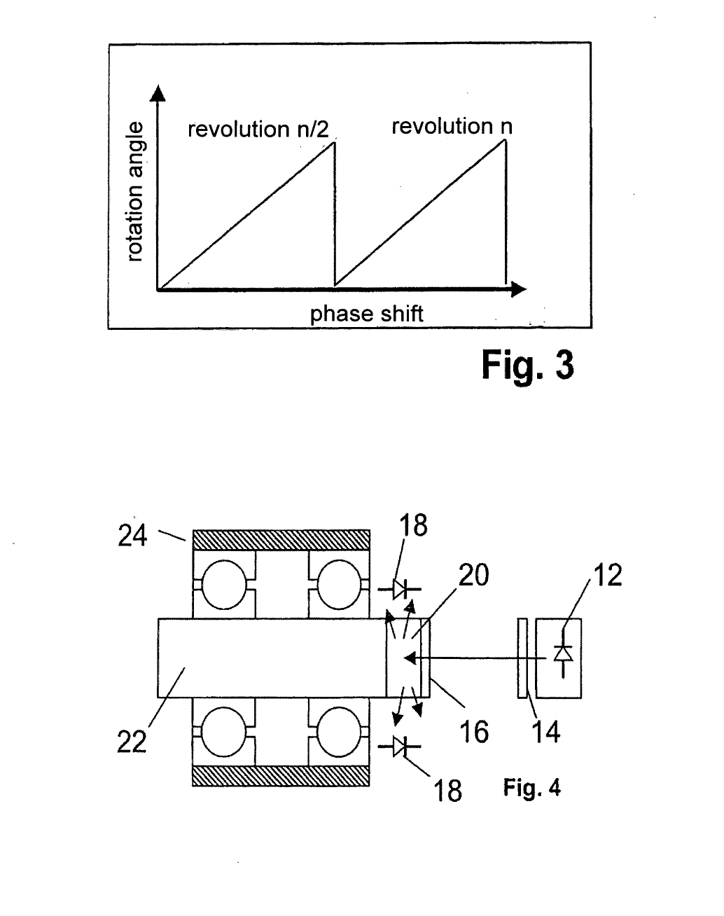

FIG. 3 a diagram showing the relationship between the rotation angle and the phase displacement of the receiver signal

FIG. 4 the device of FIG. 1, in a schematic axial section

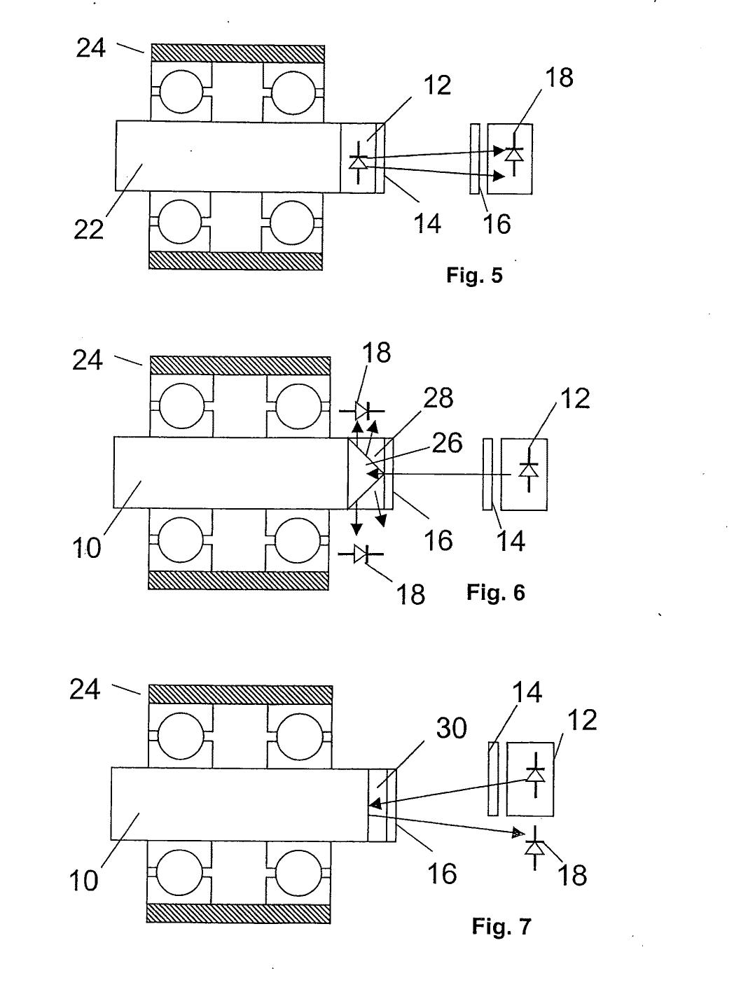

FIG. 5 a second embodiment, also in a schematic axial section

FIG. 6 a third embodiment, also in a schematic axial section

FIG. 7 a fourth embodiment, also in a schematic axial section.

The basic principle of the invention is explained on the basis of an embodiment shown in FIG. 1, in which a transmitter emits four linearly polarized light rays, whose polarization planes are each rotated 45° relative to another.

In the embodiment shown in FIG. 1, which is also schematically depicted in FIG. 4, the rotation angle (or a value dependent on the rotation angle) of a rotating object 10, e.g., a revolving shaft, is measured in relation to a reference system, e.g., the housing of a motor.

A stationary transmitter 12 emits at least two—and in the present exemplary embodiment four—linearly polarized light rays a, b, c, and d. The light rays a, b, c, and d basically run in axially parallel fashion relative to a central axis and are positioned around this central axis with an angular spacing of 90°, one relative to another. Serving to produce the light rays a, b, c, d are light sources 12.1, 12.2, 12.3, 12.4, which are advantageously provided with collimating lenses. The light rays a, b, c, d pass through a polarizer 14, which is fixed in position in front of the transmitter 12 and is composed of four polarizing filters 14.1, 14.2, 14.3, 14.4. The polarizing filters are positioned around a central axis in an array of four quadrants, whose angular position corresponds to the light sources 12.1, 12.2, 12.3, and 12.4. The polarization planes of the polarizing filters 14.1, 14.2, 14.3, 14.4 are each rotated 45° one from the other. Consequently the light rays a, b, c, d are polarized in linear fashion after passing through the polarizer 14, in such a way that their polarization planes are successively rotated by 45°.

The central axis of the transmitter 12 is basically oriented so as to be axially flush with the rotation axis of the rotating object 10. An analyzer which revolves with the object is positioned in the incident area of the light rays a, b, c, d, concentric with the rotation axis of the rotating object 10, e.g., an axle shaft. In the exemplary embodiments shown in FIGS. 1 and 4 the analyzer consists of a polarizing filter 16, e.g., a polarizing film, which is fixed in position on the rotating object. The light passing through the polarizing filter 16 reaches the receiver 18, which measures the intensity of said light and coverts it into a corresponding electrical signal.

Proceeding in the axial direction, the receiver 18 may be positioned behind the polarizing filter 16. If the rotating object 10 is tubular in shape, the receiver can be positioned in a fixed, coaxial position within the rotating object. If the receiver 18 revolves with the object 10 and the polarizing filter 16, then the receiver signals must be uncoupled in an inductive or capacitive manner.

In the exemplary embodiment shown in FIGS. 1 and 4, however, a diffusion disk is positioned between the polarizing filter 16 and the rotating object, and this diffusion disk may consist, e.g., of glass. As can be seen in FIGS. 1 and 4, the diffusion disk 20 is advantageously applied to the axial face of the rotating object 10, e.g., adhesively, while the polarizing filter 16 is in turn applied to that side of the diffusion disk 20 that faces the transmitter 12, e.g., glued on as a film. The light passing through the polarizing filter 16 is diffusely scattered by the diffusion disk, so that the scattered light leaves the diffusion disk in radial fashion and reaches the receiver 18, which is laterally positioned outside of the diffusion disk 20. Since the polarizing filter 16 and the diffusion disk 20 are positioned in rotationally symmetrical fashion relative to the rotational axis of the object 10, the intensity of the scattered light radially leaving the diffusion disk is independent of the rotation angle, and the receiver 18 can be positioned in stationary fashion.

The advantage conferred by the arrangement of the embodiment in FIGS. 1 and 4 rests specifically in the fact that the light sources of the transmitter 12 and the receiver 18 are positioned in stationary fashion and can therefore be electrically connected in a stationary manner. It is not necessary to provide an electrical connection for the rotating parts. Furthermore, the transmitter 12 with the polarizer 14, and the polarizing filter 16 with the diffusion disk 20 have a concentric design and small radial dimensions, with the result that the device can be miniaturized. The transmitter 12 and the polarizing filter 16 do not require a perfectly flush alignment in the axial direction; consequently these elements can be mounted independent of each another and without a great degree of adjustment.

To measure the rotation angle of the rotating object 10, the light sources 12.1, 12.2, 12.3, and 12.4 of the transmitter are modulated in sinusoidal fashion with respect to their transmitting power, so that the intensity of the light rays a, b, c, d is sinusoidally modulated. This modulation is such that the intensity of the light rays a, b, c, d is phase-shifted by 90° for each ray, relative to its predecessor. If the amplitude of the light ray's intensity is designated as U₀ and the modulation frequency as ω₀, the following intensity-functions result for the light rays:

a=U₀(1+sin ω₀t)

b=U₀(1+cos ω₀t)

c=U₀(1−sin ω₀t)

d=U₀(1−cos ωhd 0t) (1)

The light rays a, b, d, d, each rotated in its linear polarization relative to the next, pass unweakened through the polarized filter 16 of the analyzer if the polarization plane of the rotating polarized filter 16 coincides with the polarization plane of the individual light ray. If the polarization plane of the rotating polarized filter 16 runs perpendicular to the polarization planes of the light rays, these rays will not be allowed to pass through. As dependent on the rotation angle φ of the polarized filter 16, the intensities of the individual light rays a, b, c, d, behind the polarized filter 16 prove to be:

a(φ)=U₀(1+sin ω₀t)(1+sin φ)

b(φ)=U₀(1+cos ω₀t)(1+cos φ)

c(φ)=U₀(1−sin ω₀t)(1−sin φ)

d(φ)=U₀(1−cos ω₀t)(1−cos φ) (2)

Since the polarization planes of the polarizing filter and of the light rays in each case coincide after the polarizing filter has been rotated 180°, the rotation angle Θ of the rotating object 10 is consequently Θ=2φ.

The total quantity X of the diffused light admitted by the polarizing filter 16 and scattered in the diffusion disk is given by the sum of the intensities of all the rays a, b, c, d which pass through for this rotation angle φ, and thus equals:

$$\begin{matrix}X = a ( ϕ ) + b ( ϕ ) + c ( ϕ ) + d ( ϕ ) \\ = {U}_{0} ( 1 + sin {ω}_{0} t + sin ϕ + sin {ω}_{0} t \cdot sin ϕ ) + \\ {U}_{0 } ( 1 + cos {ω}_{0} t + cos ϕ + cos {ω}_{0} t \cdot cos ϕ ) + \\ {U}_{0} ( 1 - sin {ω}_{0} t - sin ϕ + sin {ω}_{0} t \cdot sin ϕ ) + \\ {U}_{0} ( 1 - cos {ω}_{0} t - cos ϕ + cos {ω}_{0} t \cdot cos ϕ ) \\ = {U}_{0} ( 4 + 2 ( sin {ω}_{0} t \cdot sin ϕ + cos {ω}_{0} t \cdot cos ϕ ) )\end{matrix} \qquad ( 3 )$$

Applying the conversion theorems of trigonometry:

sin α·sin β=½(cos(α−β)−cos(α+β))

cos α·cos β=½(cos(α−β)+cos(α+β)) (4)

provides the following formula for the optical intensity of the measured light:

X=U₀(4+(cos(ω₀t−φ)−cos(ω₀t+φ)+cos(ω₀t−φ)+cos(ω₀t+φ))

X=U₀(4+2 cos(ω₀t−φ)) (5)

In accordance with the received optical intensity, a signal of the receiver 18 is thus obtained which is sinusoidal, contains the modulation frequency ω₀ of the light rays a, b, c, d, and is phase-shifted in accordance with the rotation angle φ of the polarizing filter and thus of the rotating object. In the process, the phase per revolution of the object 10, or of the polarizing filter 16, is shifted by one period. The effective phase shift of the receiver signal at any given moment thus represents a measure for the effective rotation angle at that moment. The number of periods by which the receiver signal is phase-shifted corresponds to the number of the object's revolutions.

If, for example, a modulation frequency of ω₀=1 MHz is selected for the light rays a, b, c, d and if the object, e.g., a motor shaft, turns at a rate of 6000 revolutions/minute, or 100 revolutions/second, there is a phase shift of 100 periods per second and thus a received output signal with a frequency of 999.900 Hz.

FIG. 2 provides a corresponding schematic depiction of the dependency of the frequency of the measured receiver signal X on the rotating speed of the object 10.

FIG. 3 shows the relationship between the rotating angle φ of the polarizing filter 16 and the phase shift of the receiver signal over one revolution of the rotating object 10.

The embodiment shown in FIG. 1, with four light rays which are modulated in sinusoidal fashion and phase-shifted by 90° and whose linear polarization in each case is rotated by 45°, permits a signal evaluation which is particularly simple, as shown by the trigonometric derivation given above. It is clear to the specialist, however, that the invention can also be realized with a different number of light rays, with a different modulation, and with a different phase-shift in the modulation, as well as with a linear polarization of the light rays that is displaced by a different angle. However, this is generally associated with more complicated evaluating algorithms. Simple solutions are also provided when there are two light rays, however. The same simple evaluation that is described above also arises when the number of light rays is a multiple of four. The result then is a corresponding number of periods for the phase shift per revolution of the rotating object.

FIG. 4 again shows the device of FIG. 1 in a schematic depiction. Here the transmitter 12, the polarizer 14, and the light rays are only schematically depicted, without showing the division involving four light sources, four polarizer fields, and four light rays. FIG. 4 shows the compact design of the device, which permits it to have small dimensions. In particular, the polarizing filter 16 and the diffusion disk 20 can be positioned on the axial face of the shaft 22 of a motor 24. FIG. 4 also shows that a number of receivers 18, e.g., photodiodes, can also be positioned around the diffusion disk 20, to provide a better light output and thus a better reception signal.

FIG. 5 depicts a second embodiment. In this embodiment, the transmitter 12 and the polarizer 14 are firmly secured to the rotating object, e.g., the shaft 22 of a motor 24, and rotate with the shaft 22. The analyzer is accordingly placed in fixed position. The analyzer, which is formed, e.g., by a polarizing filter, can be positioned directly on the stationary receiver 18. Since in this case the light sources and their modulation circuit rotate along with the shaft 22, a capacitive or inductive energy supply to the rotating circuit is necessary.

FIG. 6 shows a third embodiment, which represents a modification of the embodiment of FIGS. 1 and 4. To divert the light that passes through the polarizing filter 16 of the analyzer radially and outward into the receiver(s) 18, a conical mirror 26 is coaxially positioned behind the polarizing filter 16. The mirror 26 can be molded into a transparent cylinder 28 positioned coaxially with the rotating object, such that the polarizing filter 16 is applied to the face of this cylinder 28. This results in a better light output than is the case with the diffuse scattering provided by the diffusion disk 20. However, the conical mirror 26 increases the overall axial length as compared to the diffusion disk 20.

FIG. 7 shows a fourth embodiment, which is a modification of the embodiment of FIG. 6. Positioned behind the polarizing filter 16 is a mirror 30, which lies parallel to the polarizing filter 16. The light passing through the polarizing filter 16 is reflected back by this mirror 30 and reaches the receiver 18, which in the present case is positioned next to the transmitter 12.

It is clear to the specialist without further explanation that the employed analyzer does not need to be a polarization filter, but may also be a polarization-sensitive device that admits or reflects the polarized light in dependence on the rotating angle.

### LIST OF REFERENCE NUMERALS

10 rotating object
12 transmitter
14 polarizer
16 polarizing filter
18 receiver
20 diffusion disk
22 shaft
24 motor
26 mirror
28 cylinder
a light ray
b light ray
c light ray
d light ray

1. Process for measuring the rotation angle between two objects which rotate relative to each other, such that a transmitter assigned to one of the objects transmits linearly polarized light and this light passes through an analyzer and strikes a receiver, and such that the transmitter and the analyzer revolve, one relative to the other, in dependence on the rotation angle, and such that the optical intensity measured by the receiver is evaluated as a signal that is dependent on the angle of rotation,
wherein
the transmitter (12) transmits at least two linearly polarized light rays (a, b, c, d), whose polarization planes are rotated relative to each other, and the intensity of these light rays (a, b, c, d) is periodically modulated in phase-shifted fashion, each relative to the other.

2. Process according to claim 1,
wherein
the intensity of the light rays (a, b, c, d) is modulated in sinusoidal fashion.

3. Process according to claim 1,
wherein
the intensity of the light rays (a, b, c, d) is modulated in rectangular fashion.

4. Process according to claim 1,
wherein
the polarization planes of the light rays (a, b, c, d) are each rotated by 180°/n relative to each other, where n is the number of light rays (a, b, c, d).

5. Process according to claim 1,
wherein
the intensity of the light rays (a, b, d, c) undergoes a phase-shifted modulation of 360°/n, for each of said rays relative to the other.

6. Process according to claim 4,
wherein
four light rays (a, b, d, c) are emitted.

7. Device for measuring the rotation angle of two objects which rotate relative to each other, with a transmitter (12), which is assigned to one of the objects and which transmits linearly polarized light, with an analyzer sensitive to polarization, such that the transmitter and the analyzer revolve relative to each other as dependent on the rotation angle, and with a receiver (16) which measures the intensity of the light passing through the analyzer, in order to produce a signal that is dependent on the angle of rotation,
wherein
the transmitter (12) has at least two light sources (12.1, 12.2, 12.3, 12.4) which emit linearly polarized light rays (a, b, c, d), the polarization planes of these light rays (a, b, c, d) are rotated relative to each other, and the intensity of these light rays (a, b, d, c) is periodically modulated in phase-shifted fashion, each relative to the other.

8. Device according to claim 7,
wherein
the light sources (12.1, 12.2, 12.3, 12.4) are advantageously positioned at equal angular intervals around the axis of rotation.

9. Device according to claim 7,
wherein
the analyzer has a polarization filter (16).

10. Device according to claim 7,
wherein
the transmitter (12), along with the light sources (12.1, 12.2, 12.3, 12.4), is positioned in stationary fashion, while the analyzer revolves.

11. Device according to claim 7,
wherein
the transmitter (12), along with the light sources (12.1, 12.2, 12.3, 12.4), revolves, while the analyzer is positioned in stationary fashion.

12. Device according to claim 10,
wherein
the receiver (18) is positioned in the direction of radiation, behind the polarization filter (17).

13. Device according to claim 12,
wherein
the receiver (18) is positioned in stationary fashion behind the rotating polarization filter (16).

14. Device according to claim 12,
wherein
the receiver (18) revolves with the polarization filter (16), and the receiver signals are uncoupled in inductive or capacitive fashion.

15. Device according to claim 10,
wherein
a light-deflecting unit that revolves with the analyzer is positioned behind said analyzer, and this light-deflecting unit deflects into the receiver the light passing through the analyzer.

16. Device according to claim 15,
wherein
light passing through the analyzer is deflected by the light-deflecting unit in radial fashion relative to the rotation axis, and the receiver (18) is radially positioned outside of the light-deflecting device.

17. Device according to claim 16,
wherein
the light-deflecting device is a diffusion disk (20).

18. Device according to claim 16
wherein
the light-deflecting device (26) is a mirror.

19. Device according to claim 15,
wherein
the light-deflecting device is a mirror (30) placed perpendicular to the rotation axis, and the receiver is located next to the transmitter (12).
